(19) United States
(12) Patent Application Publication
(10) Pub. No.: US 2002/0033991 A1
(43) Pub. Date: Mar. 21, 2002

(54) Point probe memory with light modulator readout

(76) Inventor: Charles F. Hester, Huntsville, AL (US)

Correspondence Address: Banner & Witcoff, Ltd., 1001 G Street, N.W., Washington, DC, 20001-4597, US

(21) Appl. No.: 09/790,323

(22) Filed: Feb. 21, 2001

Related U.S. Application Data
(60) Provisional application No. 60/183,261, filed on Feb. 17, 2000.

(51) Int. Cl. G02B 26/00

(52) U.S. Cl. 359/290; 359/291; 359/295

(57) ABSTRACT

A memory cell that includes a memory media electronically storing information, and a read unit for reading information in the memory media and converting the read information into an optical signal. The read unit includes a point probe and a spatial light modulator. The point probe reads information from the memory media, which produces a charge at the probe. This charge, corresponding to the information electronically stored in the memory media, is then used to control the operation of the spatial light modulator so that the modulator modulates light to convey the information read from the memory media. The read unit may also include an output amplifier, for amplifying the signal output from the point probe used to control the spatial light modulator. The read unit may also include a drive amplifier, for providing power to the point probe to allow it to write information to the memory media.

### RELATED APPLICATIONS

This application is a continuation in part application of earlier Provisional Patent Application No. 60/183,261, filed on Feb. 22, 2000, naming Charles F. Hester and Charles A. Whitehead as inventors, which provisional patent application is incorporated entirely herein by reference.

### BACKGROUND OF THE INVENTION

The invention relates to an electronic memory that is read by way of a light modulator, such as a spatial light modulator.

Optical processor systems typically require memory to operate, and conventional electronic memories are often employed for this task. With this arrangement, the digital output of the electronic memory is converted to an optical signal with a light modulator, such as a spatial light modulator. These conventional electronic memories require a great deal of associated electronics, however, necessary to read the memory's digital output, convert the digital output to an analog signal, and then apply the analog signal to the light modulator.

Optical processor systems have also employed optical memories with holographic storage. These memories are limited to the resolution of the light medium, however, which is typically no smaller than 1 micron. Holographic storage can provide higher densities with spatial or wavelength multiplexing, but these densities are still relatively small when compared with densities for conventional electronic memories. Accordingly, there is a need for a high density, relatively simple memory for optical systems.

### SUMMARY OF THE INVENTION

Advantageously, various embodiments of the invention provide an apparatus and method for conveniently and easily converting electronically stored information into optically conveyed information. More particularly, the invention provides a memory cell that includes a memory media electronically storing information, and a read unit for reading information in the memory media and converting the read information into an optical signal. According to various embodiments of the invention, the read unit includes a point probe and a spatial light modulator. The point probe reads information from the memory media, which produces a charge at the probe. This charge, corresponding to the information electronically stored in the memory media, is then used to control the operation of the spatial light modulator so that the modulator modulates light to convey the information read from the memory media. The read unit may also include an output amplifier, for amplifying the signal output from the point probe used to control the spatial light modulator. The read unit may also include a drive amplifier, for providing power to the point probe to allow it to write information to the memory media.

### BRIEF DESCRIPTION OF THE DRAWINGS

FIG. 1 illustrates a memory cell according to an embodiment of the invention.

FIG. 2 schematically illustrates movement of a read unit relative to a memory media according to various embodiments of the invention.

FIG. 3 schematically illustrates an amplifier formed from a CMOS field effect transistor according to various embodiments of the invention.

FIG. 4 shows a memory cell according to another embodiment of the invention.

FIG. 5 illustrates a memory cell according to yet another embodiment of the invention.

FIG. 6 shows a switching circuit for switching between an output amplifier and a drive amplifier according to various embodiments of the invention.

FIG. 7 illustrates a memory cell according to still another embodiment of the invention.

FIG. 8 shows a memory cell according to still yet another embodiment of the invention.

FIG. 9 shows a memory cell according to yet another embodiment of the invention.

FIG. 10 illustrates a memory cell according to still another embodiment of the invention.

FIG. 11 illustrates an array of memory cells according to various embodiments of the invention.

FIG. 12 illustrates a comb drive that can be employed to move an array of memory cells according to various embodiments of the invention.

FIG. 13 illustrates another array of memory cells according to various embodiments of the invention.

FIG. 14 illustrates an application of memory cells according to various embodiments of the invention in an optical correlator.

### DESCRIPTION OF PREFERRED EMBODIMENTS OF THE INVENTION

A memory cell 100 according to one preferred embodiment of the invention is shown in FIG. 1. As seen from this figure, the memory cell 100 includes a memory media 102 and a read unit 104 for reading the memory media 102. The read unit 104 is positioned above the memory media 102, and includes a point probe 106, a substrate 108, and an amplifier 110. The read unit 104 also includes a grating 112, which serves as a spatial light modulator. The substrate 108 supports the point probe 106 and the amplifier 110. The grating 112 may also be supported on the substrate 108, or it may be independently supported.

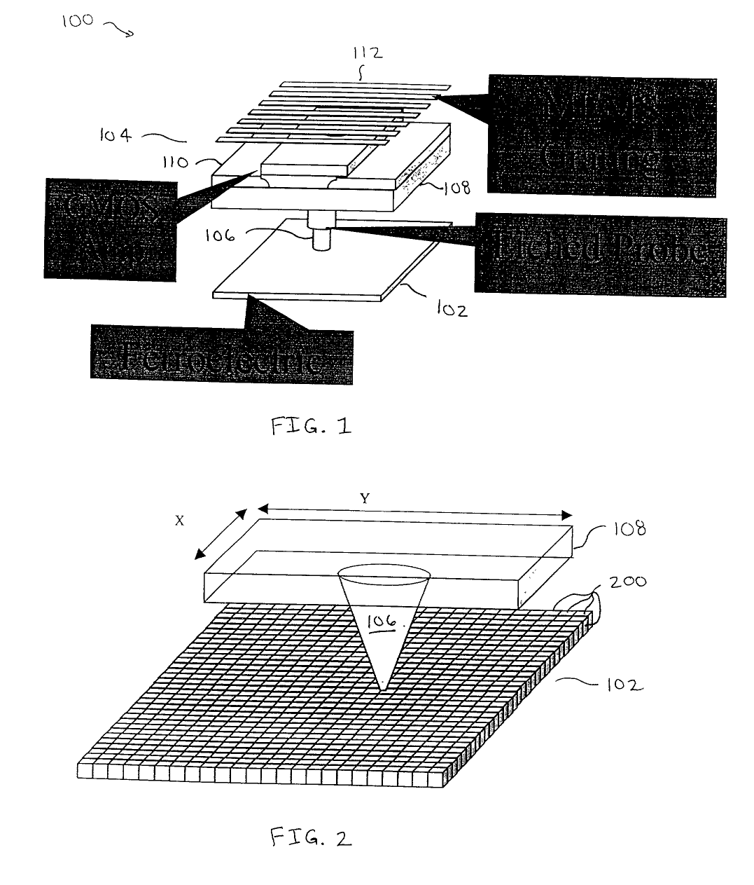

The memory media 102 includes a number of individually addressable memory domains 200 (see FIG. 2). As explained in more detail below, the physical state of each of these domains 200 can be changed to store information in the media 102. The substrate 108 is movable over the surface of the media 102, so that the point probe 106 can detect differences in the states of the domains 200 over the surface of the media 102. The amplifier 110 then amplifies the output of the point probe 106, and the output of the amplifier 110 drives the grating 112. In this way, the information stored in the media 102 is transformed into an optical signal.

FIG. 2 shows the media 102 in greater detail. As can be seen in this figure, the different domains 200 of the media 102 are arranged in a grid pattern. Each of these domains 200 can be switched between at least two different states, so that together they can be controlled to store information. While the point probe 106 and substrate 108 are relatively large compared with each domain 200, the tip of the point probe 106 is small enough to individually address each domain 200. Preferably, the substrate 108 can move the point probe 106 in both the X-axis and Y-axis direction, thereby allowing the point probe to access each domain 200 of the media 102.

The media 102 may be formed of be any type of suitable memory material, including any magnetic, ferroelectric, or other type of material that can be read by capacitive coupling, quantum tunneling, or magnetic coupling. In fact, the media 102 may be formed of any type of material producing a physical interaction that creates, or can be converted into, an electric charge. In some embodiments, for example, the media 102 may be formed from a thin, flat sheet of magnetic film, such as a film of Cr-based system material. Alternately, the media may be formed of a host material, such as glass or a polymer, imbedded with a media material, such as a ferroelectric or magnetic material. For example, glass impregnated with SrBi₂Ta₂O₉ or NaKC₄H₄O₆4H₂O can be formed with domains on the order of 10 nm. Preferably, the media 102 allows memory domains 200 to be formed with a high density.

The manufacture and use of such memory material is well known in the art. See, e.g., “Rochelle Salt Nanocrystals Embedded In Porous Glass,” by E. K. Jang et al., ISAF '94, Proceedings of the Ninth IEEE Symposium on Applications of Ferroelectrics, 1994, pages 210-213, which is incorporated entirely herein by reference. This article discloses a glass material that can be employed for media 102. Similarly, “A New Electrode Technology For High-Density Nonvolatile Ferroelectric (SrBi₂Ta₂O₉) Memories,” by Jiang et al., 1996 Symposium On VLSI Technology Digest Of Technical Papers, 1996 IEEE, which is incorporated herein by reference, and “A 60 ns 1Mb Nonvolatile Ferroelectric Memory With Non-Driven Cell Plate Line Write/Read Scheme,” by Hiroki Koike et al., 1996 IEEE International Solid State Circuits Conference, which also is incorporated herein by reference, disclose other materials that can be used for the media 102. Still further, “A Simple Unified Analytical Model For Ferroelectric Thin Film Capacitor And Its Applications For Nonvolatile Memory Operation,” by Deng-Yuan Chen (CH3416-5 0-7803-1847-1/95/1995IEEE), which is incorporated herein by reference, discloses memory media.

With conventional technology, the point probe 106 can be manufactured to read domains of very high densities, on the order of 1-10 nanometers at its tip, and expanding to 1 μm at its base. Preferably, the probe is etched from a doped p-silicon layer with an isotropic etch in a backside processing step. The manufacture of such point probes may be found in, for example, “200-nm Gated Field Emitters,” by Z. Huang et al., IEEE Electron Device Letters, Vol. 14, No. 3, March 1993, which is incorporated herein by reference. “A Fabrication Method For The Integration Of Vacuum Microelectronic Devices,” by Steven Zimmerman et al., IEEE Transactions On Electron Devices, Vol. 38, No. 10, October 1991, and “‘Microtips’ Fluorescent Display,” by P. Vaudaine et al., Technical Digest, International Electron Devices Meeting, 1991, pages 197-200, both of which are incorporated herein by reference, also disclose the manufacture of point probes. In some embodiments, the substrate 108 supporting the probe 106 is a plate 1-100 μm in length.

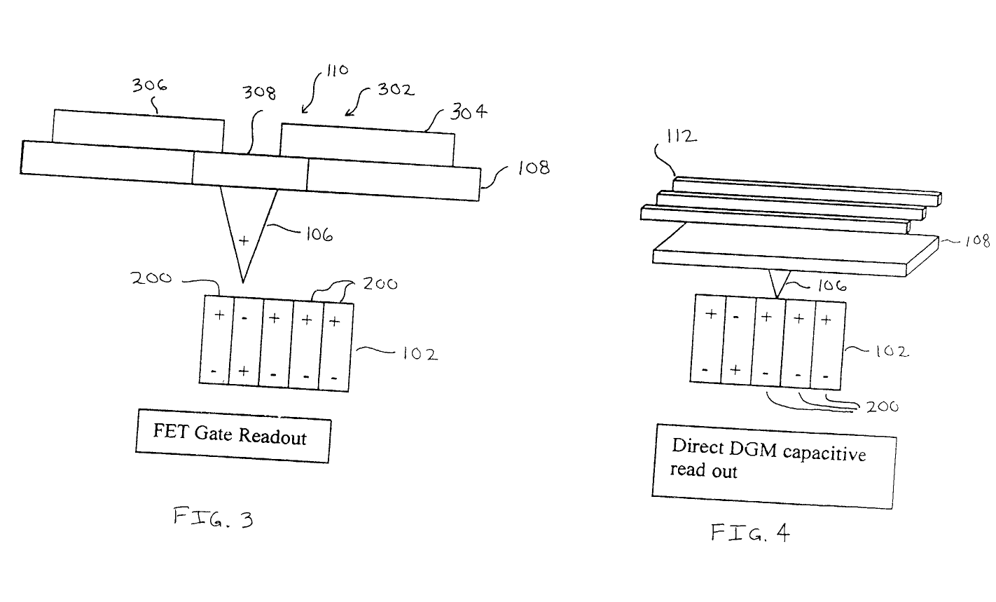

One embodiment of the invention, where the amplifier 110 is formed of a CMOS field effect transistor 302, is shown in FIG. 3. In this embodiment, the field effect transistor 302 includes a drain 304, a source 306, and a channel layer 308. The probe 106 then acts as the gate for the field effect transistor 302. As shown in the figure, when sufficient charge is applied to the probe 106 from a memory domain 200, the field effect transistor 302 is turned on, causing current to flow from the drain 304 to the source 306 through the channel layer 308.

While this embodiment employs the probe 106 as the gate for a transistor, a separate gate, electrically connected to the probe 106, may also be employed. Also, while the illustrated embodiment has the channel layer 308 formed within the substrate 108, a separate channel layer could alternately be used. Further those of ordinary skill in the art will appreciate that other embodiments of the invention may employ different types of field effect transistors. Still further, some embodiments may employ other types of amplifiers, such as junction transistors.

The embodiment of the invention shown in FIG. 1 includes a grating 112 of a spatial light modulator. With this type of spatial light modulator, capacitance between the bars of the grating and one or more control electrodes determines the vertical position of the grating bars. For example, when the capacitance between a grating bar and a control electrode below the bar increases, the bar is pulled down toward the electrode. In this manner, the vertical position of the grating, and thus the diffraction of the grating, can be variably controlled. This type of light modulator is known in the art. For example, the manufacture and use of this type of spatial light modulator are disclosed in, for example, U.S. Pat. No. 5,808,797 to Bloom et al., issued Sep. 15, 1998, U.S. Pat. No. 5,841,579 to Bloom et al., issued Nov. 24, 1998, and U.S. Pat. No. 5,982,553 to Bloom et al., issued Nov. 9, 1999, each of which are incorporated herein by reference.

With the embodiment of the invention shown in FIG. 3, the gate capacitance produced by the point probe 106 drives the position of the bars of the grating 112. Alternatively, however, the power provided by the amplifier 110 may be used to drive a separate control electrode for the grating 112. This arrangement is useful when the amplifier is not a field effect transistor, but some other type of amplifier.

Still another embodiment of the invention is shown in FIG. 4. This embodiment is similar to that illustrated in FIG. 1, but omits amplifier 110. Instead, a charge sensed by point probe 106 produces a capacitance directly between the substrate 108 and the bars of grating 112, to control the position of the grating bars. This arrangement can be employed where the individual domains 200 create sufficient charge in the probe 106 to affect the position of the grating bars. For example, this arrangement can be used with memory domains 200 that provide a charge between 0.1 to 100 femta Coulombs. For some conventional media, the approximate charge at the media surface is approximately 10 femta Coulombs per square nanometer. Thus, with only moderate coupling for a conventional media, the amplifier 110 can be omitted, and direct deflection of the grating bars can be employed.

As previously noted, FIG. 1 illustrates an embodiment using a deformable grating as the spatial light modulator. The use of this type of light modulator allows the memory to be read with both coherent and incoherent light. Other embodiments can employ different types of spatial light modulators, however, such as, for example, a ferroelectric liquid crystal light modulator. Further, still other embodiments can employ other types of light modulators, including modulators that modulate light over time.

FIG. 5 shows yet another embodiment of the invention. This embodiment includes a photocell 502 positioned on the substrate 108. The photocell 502 provides power to drive the amplifier 110. With this arrangement, the light employed to read information from the memory cell 100 also powers the operation of the memory cell 100. The photocell 502 may be formed of silicon or any other material or structure that converts incident light into electrical power.

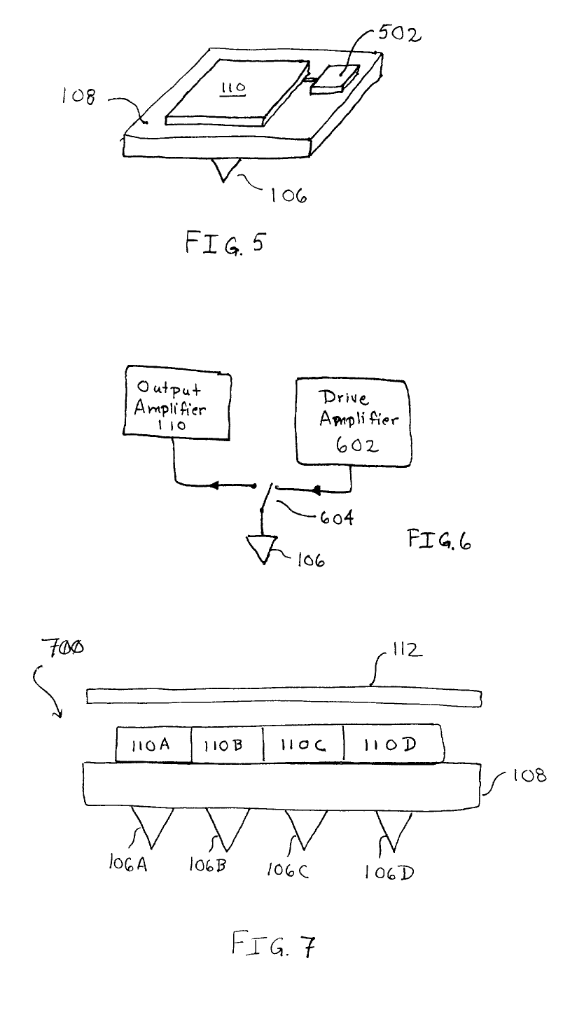

Information can be written into the media 102 with the point probe 106. Before a write operation, the probe 106 is switched from output amplifier 110 to a drive amplifier 602 by a switch 604, as shown in FIG. 6. When the drive amplifier 602 is activated, the probe 106 can change the state of a domain, allowing information to be written to the domain. If the embodiment includes the photocell 502, then the drive amplifier 602 can be connected to the photocell 502 as well. This arrangement allows the memory cell 100 to write information in a domain simply by receiving light from a light source.

Another embodiment of the invention is shown in FIG. 7. This embodiment is similar to that shown in FIG. 1, but has a number of point probes 106. Multiple probes 106 allow the memory cell 700 to convert multiple bits stored in different domains of the memory media 102 into an analog light signal. For example, each probe can be configured to provide twice as much “weight” for controlling the grating 112 as the next probe. For example, if probe 106A alone produces a capacitance of X between the gating 112 and its control electrode, then probe 106B produces a capacitance of 2X, probe 106C produces a capacitance of 4X, and probe 106D produces a capacitance of 8X. Thus, the embodiment shown in FIG. 7 can convert a four-bit word into an equivalent analog optical signal.

The “weighting” of the probes 106 can be implemented in a number of different ways. For example, as shown in FIG. 7, each point probe 106 is connected to a separate amplifier 110. Each amplifier 110 has a different amplification gain, in multiples of two starting from the amplifier corresponding to the lowest bit. That is, amplifier 110A provides an amplification of G, amplifier 110B provides an amplification of 2G, amplifier 110C provides an amplification of 4G, and amplifier 110D provides an amplification of 8G. The outputs of each amplifier are then combined and applied to the control electrode for grating 112. The deflection of the grating 112 (and the resulting optical signal) thus corresponds to the digital value stored in the four different domains read by the four probes 106.

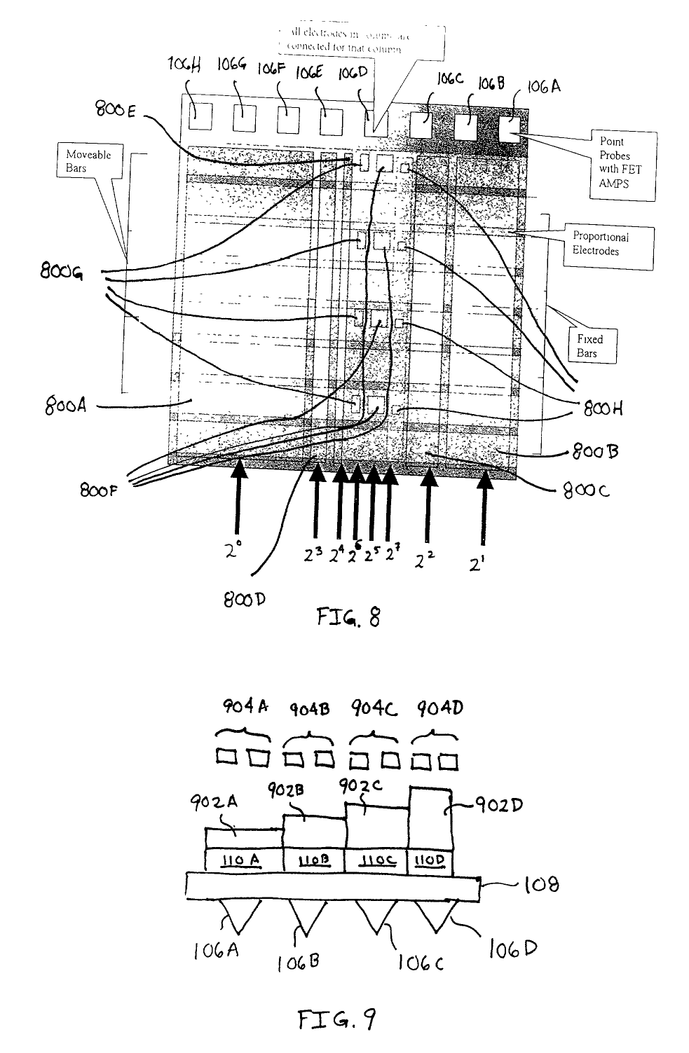

An alternative embodiment can employ multiple control electrodes, as shown in FIG. 8. With this embodiment, each of the control electrodes 800 corresponds to a specific point probe 106. Here, the amplifications of the amplifiers 110 are equal, but the areas of the corresponding control electrodes 800 are different. Because the capacitance produced by a control electrode 800, given a fixed amount of charge, is inversely proportional to its area, the control electrode 800H corresponding to point probe 106H for the highest bit (i.e., the most significant bit) has the smallest area (i.e., four square electrode areas shown in FIG. 8). For example, if control electrode 800G has an area of A, then control electrode 800G has an area of 2A. Further, control electrode 800F has an area of 4A, while control electrode 800E has an area of 8A. Control electrodes 800D, 800C, 800B, and 800A have areas of 16A, 32A, 64A and 128A, respectively.

As shown in FIG. 8, the areas of each control electrode 800 are arranged in a column. (While electrodes 800F, 800G, and 800H have separate electrode areas, all of the areas for each electrode are positioned in a single column and electrically connected.) The columns are interleaved, in order to more evenly distribute the pull of each control electrode 800 over the area of the grating 112. Other embodiments can employ different arrangements of the control electrodes 800, however, such as arranging the electrodes in a concentric manner.

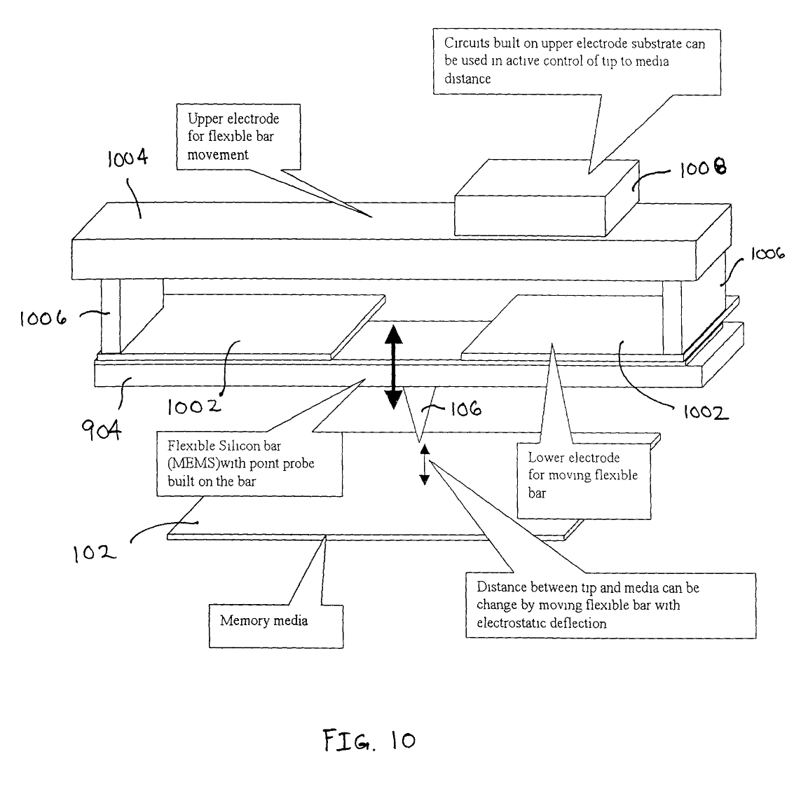

Yet another embodiment of the invention employs different modulation depths for each probe 106. As shown in FIG. 9, each point probe 106 may correspond to a control electrode 902 and one or more grating bars 904 of the grating 112. Moreover, the depth between the control electrode 902 and its corresponding grating bar or bars 904 varies depending upon the significance of the point probe 106. If point probe 106A reads the least significant bit of a four-bit binary word stored in memory, then the distance between control electrode 902A and grating bars 904A is relatively large. The distance between control electrode 902B and grating bars 904B is then smaller, and the distance between control electrode 902C and grating bars 904C is smaller still. The smallest distance is then between control electrode 902D and grating bars 904D, which correspond to point probe 106D for reading the most significant bit of the binary word.

Yet another embodiment of the invention is shown in FIG. 10. In this embodiment, the point probe 106 is mounted or built directly onto a bar 904 of grating 112. The position of the bar 904 is then controlled by a pair of lower electrodes 1002 and an upper electrode 1004 held above the lower electrodes 1002 by a pair of supports 1006. With this arrangement, the position of the point probe 106, relative to the memory media 102, is determined by the operation of the electrodes 1002 and 1004 on the grating bar 904. This allows the position of the point probe 106 to be actively controlled to compensate for, e.g., manufacturing variations in each point probe. Circuits 1008 mounted on, for example, the electrode bar 1004 can employ feedback loops to position the point probe 106.

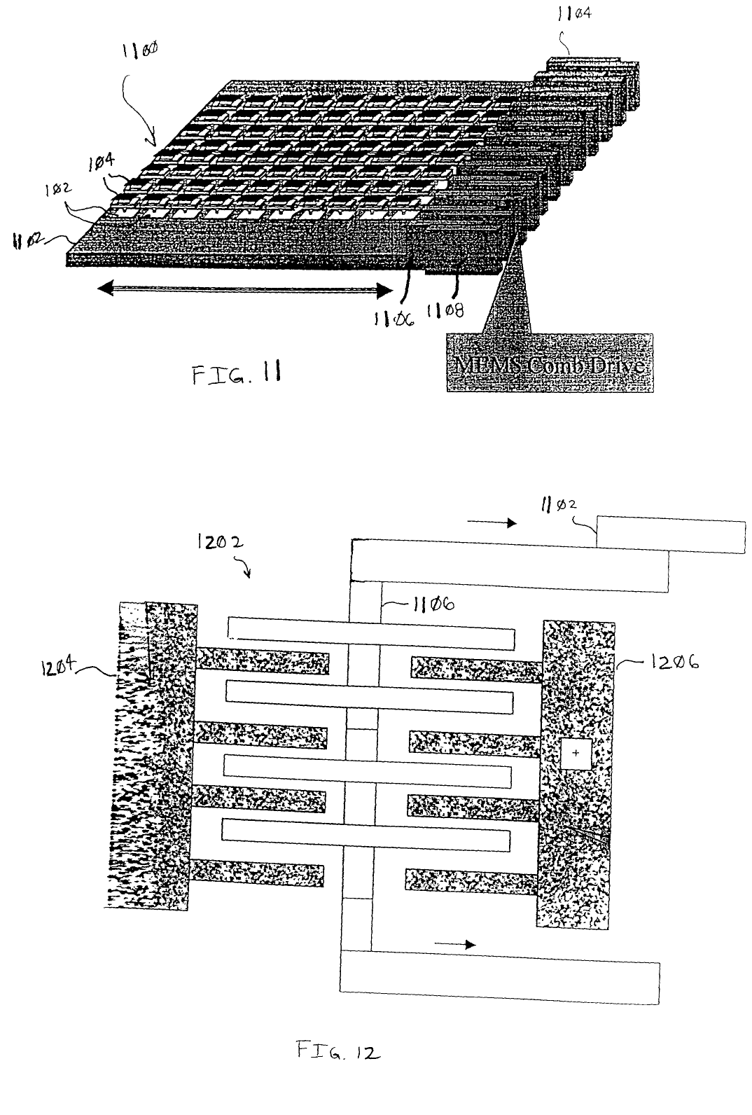

Still another embodiment of the invention is illustrated in FIG. 11. In this embodiment, a number of memory cells 100 are arranged into an array 1100. More specifically, each memory media 102 is arrayed on a platform 1102, and its corresponding reading unit 104 is held above the memory media 102. The platform 1102 is connected to a microelectromechanical actuators (MEMS) comb drive 1104. The comb drive 1104 includes a movable comb 1106, and a fixed comb 1108.

As is known in the art, when the movable comb 1106 and fixed comb 1108 are given opposite charges, the movable comb 1106 moves toward the fixed comb 1108. When the movable comb 1106 and fixed comb 1108 are given the same charge, the movable comb 1106 then moves away from the fixed comb 1108. In this manner, the movable comb 1106 can be moved back and forth, allowing each reading unit 104 to access different domains of its corresponding memory media. Further, because the memory media are moved simultaneously, the reading units 104 address the different domains at the same time. Another type of comb drive 1202 is shown in FIG. 12. This comb drive operates in the same manner as comb drive 1104 shown in FIG. 11, but includes two juxtaposed drive combs 1204 and 1206. Such comb drives are known in the art, and one of ordinary skill would know how to make and use such comb drives. See, for example, “A Lateral Capacitive CMOS Accelerometer With Structural Curl Compensation,” by Gang Zhang et al., Twelfth IEEE International MEMS Conference in Orlando, Fla., Jan. 17-21, 1999.

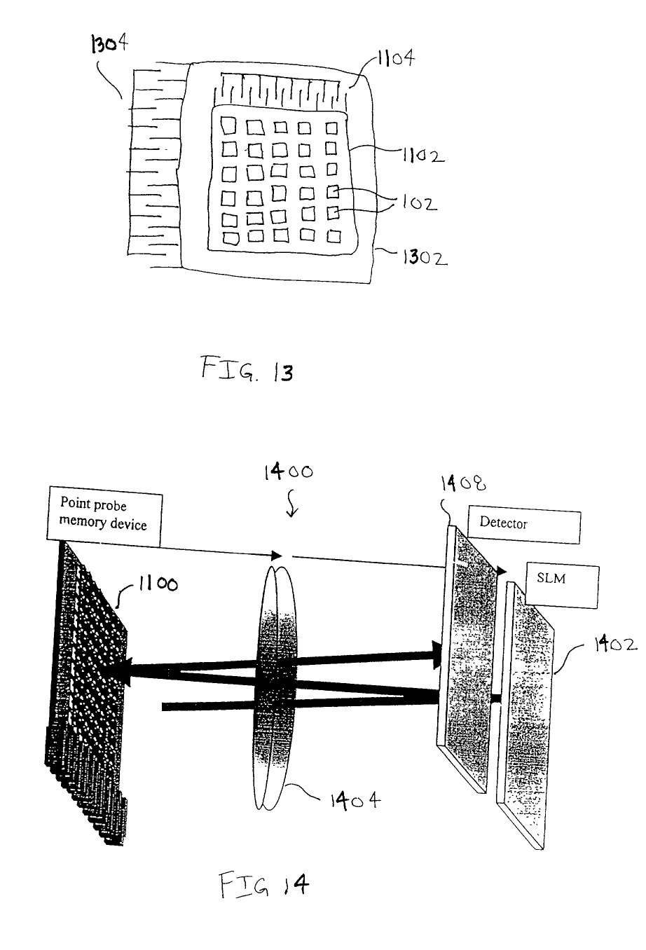

While the embodiment of the invention shown in FIG. 11 allows the memory media 102 to move back and forth in one direction (e.g., the X direction), it does not allow movement in the transverse direction (the Y direction). As shown in FIG. 13, however, this embodiment can be placed on a second platform 1302 connected to a second comb drive 1304. If the movement direction of the second comb drive 1304 is transverse to the movement direction of the first comb drive 904, then the memory media can be moved forward and backward in both the X and Y directions.

A memory according to the invention can be employed for a variety of purposes. One such use, shown in FIG. 14, is as a filter for an optical correlator 1400. With this arrangement, an optical signal is reflected off of a spatial light modulator 1402 through a lens 1404. The optical signal is then reflected from the spatial light modulators of a memory array 1100 according to the invention. The optical signal reflected from the memory array 1100 corresponds to the contents being read from the memory media 102. Thus, the memory acts to filter the optical signal. The filtered signal is then reflected back through the lens 1404 to a detector 1408 for analysis.

Although the present invention has been described with respect to specific examples and embodiments, it will be apparent to those of ordinary skill in the art that the invention is not limited to these specific examples and embodiments, but extend to other embodiments as well. The invention encompasses these other embodiments, as will be appreciated by those of ordinary skill in the art based upon the teachings above.

What is claimed is:

1. A memory cell comprising:
a memory media having a plurality of individually addressable memory domains; and
a read unit for reading information from each of the plurality of individually addressable memory domains, the read unit including
a point probe facing the memory media for detecting information in one of the plurality of individually addressable memory domains, and
a spatial light modulator controlled by a signal output from the point probe in response to reading the one of the plurality of individually addressable memory domains.

2. The memory cell of claim 1, further including an output amplifier for amplifying the signal output from the point probe.

3. The memory cell of claim 2, wherein the output amplifier is a field effect transistor.

4. The memory cell of claim 3, wherein the signal is a charge produced by the point probe, which charge is applied to a gate of the field effect transistor such that a capacitance produced by the field effect transistor in response to the applied charge operates the spatial light modulator.

5. The memory cell of claim 2, further including a photocell for powering the output amplifier.

6. The memory cell of claim 1, wherein the spatial light modulator is a grating type spatial light modulator.
